(19) United States
(12) Patent Application Publication
(10) Pub. No.: US 2007/0294156 A1
(43) Pub. Date: Dec. 20, 2007

(54) METHODS AND APPARATUS FOR ITERATIVE CONDITIONAL PROBABILITY CALCULATION METHODS FOR FINANCIAL INSTRUMENTS WITH PATH-DEPENDENT PAYMENT STRUCTURES

(76) Inventors: Webster Hughes, Charlotte, NC (US); Charles Fefferman, Princeton, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/751,188

(22) Filed: May 21, 2007

Related U.S. Application Data
(60) Provisional application No. 60/813,641, filed on Jun. 14, 2006.

(51) Int. Cl. G06Q 40/00; G06F 17/10

(52) U.S. Cl. 705/36 R

(57) ABSTRACT

Methods and apparatus provide for calculating expected present values and conditional probabilities of future payments of path-dependent rules-based securities or derivative contracts using iterative conditional probability calculation methods, including: (a) breaking a payment horizon of the securities or derivative contracts into N time increments over time t=0 to t=N; (b) initializing an array of state variables to assumed values at t=0; (c) applying transition probability models to the assumed values of the state variables at time t=0 and calculating a joint probability distribution for the state variables at time t=1; (d) applying payment calculation models to both the t=0 and t=1 values of the state variables and calculating probabilities and expected present values for the securities or derivative contracts payments occurring between t=0 and t=1 based on values of the state variables at times t=0 and t=1; (e) repeating steps (c)-(d) iteratively at each time t and calculating joint probability distributions for the state variables, probabilities, and expected present values of the the securities or derivative contracts payments occurring between times t and t+1 based on values of the state variables at times t and t+1; and (f) summing the probabilities and the expected present value calculations across time and values of the state variables to obtain the expected present values and conditional probabilities of the future payments of the path-dependent rules-based securities or derivative contracts.

### CROSS REFERENCE TO RELATED APPLICATIONS

This application is based on and claims the benefit of U.S. Provisional Patent Application No.: 60/813,641, filed Jun. 14, 2006, the entire disclosure of which is hereby incorporated by reference.

### BACKGROUND

The current invention relates to models, algorithms, software, and computing systems used to analyze specific types of financial market securities and derivative products.

A variety of financial products exist, including but not limited to, asset-backed securities (ABS), mortgage-backed securities (MBS), commercial mortgage-backed securities (CMBS), collateralized mortgage obligations (CMO), collateralized debt obligations (CDO), and collateralized loan obligations (CLO). These security types are generally referred to as “structured products”. Individual securities are often referred to as tranches. The current invention may also be applied to synthetic (i.e., derivative) products based off (i.e., derived from) structured product assets. Examples of synthetic structured products include: synthetic CDO, synthetic CLO, credit default swap (CDS), and single-tranche structured product CDS. Individual derivative contracts are often referred to as classes.

An important defining feature within these product types is that payments depend on the cash-flow performance (or value) of pools of underlying assets according to mathematical rules and formulas. Payments may also depend on observable market variables such as interest rates and financial market indices, sometimes also according to complex formulas. These observable market variables are usually referred to as payment reset indices. Underlying assets may include home mortgages, commercial real estate mortgages, consumer loans, specific property holdings, property return indices. Underlying assets may also include other structured product securities or derivatives, thereby requiring the application of multiple levels of mathematical payment rules and formulas.

Security and derivative contract payment schedules and rules are typically defined within a security prospectus or deal term sheet. Security prospectuses and derivative contracts will typically reference a calculation agent responsible for applying payment rules to reference information and calculating payments. In some cases, underlying assets are maintained in a trust from which the trustee collects cash-flow, reports performance, and disburses security payments in accordance with payment rules. In other cases, underlying assets are used solely as reference information for payment calculations, but not for actually providing cash-flow. An example of this is commercial real estate property derivatives in which payments are calculated from institutional property return indices. In this case, the reference performance information is calculated and reported by an unaffiliated third-party.

Various software systems exist for the purpose of calculating payments on structured product securities and derivative contracts. Cash-flow calculation systems are typically a component system within more extensive analytical systems that enable a range of analyses based on these cash-flow calculations. A cash-flow calculation component system uses mathematical rules and databases to encode, store, and apply defining characteristics and performance data for underlying assets, payment reset indices, and payment calculation rules. Cash-flow calculation systems are used to calculate actual payments based on actual asset performance and reset index data, as well as to calculate possible future payments based on user-defined scenarios for future asset performance and reset indices. Examples of commercially available systems are Bloomberg, INTEX, and Trepp. Major broker-dealers and institutional investors also utilize proprietary systems for certain types of securities and contracts.

Analysis of future cash-flows is a primary component of structured product investment and derivative trading technology. Scenario cash-flow analysis is typically based on calculating potential future cash-flows across of set of possible future economic scenarios. Scenario forecast models are used to translate economic input variables into security or derivative payment calculation input variables. Two types of input variables and models are required to generate scenarios for future cash-flow: 1) payment calculation input variables are required to calculate future payments; and 2) forecast model input variables are required to generate payment calculation input variables.

An example security is a 30-yr fixed rate residential mortgage backed security utilizing a senior/subordinate credit enhancement structure. In this instance, the underlying assets consist of a pool of 30-year fixed rate mortgages collateralized by single family homes. Monthly bond payments are determined by the amount of loan principal and interest payments received from homeowners (borrowers) on each loan. Payments are then divided among senior and subordinate bonds in a manner than prioritizes scheduled principal and interest payments to senior bonds. When defaults occur, subordinated bond principal balances are reduced and larger percentages of principal and interest payments are directed to senior bonds. When defaulted loans are resolved through sale of collateral, recovery amounts are then redirected to senior or subordinated bonds according to rules based on total loan losses to date in relation to total principal payments due on bonds.

Additional bonds (tranches) may also be created by further sub-allocating principal and interest payments among respective additional tranches. For example, a first bond tranche may include the first X % of principal due on the most senior bond tranche plus interest calculated at a rate interest equal to 3-month T-Bills plus 85 bp subject to a 7% rate CAP. Such additional tranches may be created from either senior bonds or subordinated bonds. Finally, residual (sometimes called equity) tranches can be created to which receive all excess principal and interest loan payments over-and-above scheduled payments on all other tranches. In many cases, this residual tranche would consist only of excess interest payments.

In this example, payment calculation input variables include current and historical values for loan principal and interest payments, defaults, and recoveries. Primary economic drivers for these payment calculation input variables would be loan refinancing rates, home prices, and homeowner income growth. Scenario forecast models may include these and/or other economic variables to create scenarios for payment calculation input variables. Scenario forecast models typically apply economic input variables to loan pool characteristics to generate payment calculation input variables.

Payment calculations at future points in time often depend strongly on underlying asset performance (principal payments, defaults, losses) prior to that time. This feature is called “path dependency.” Path-dependency manifests itself both in payment calculation rules and scenario forecast models. Because of path-dependency, information about prior-period payments and underlying asset performance is typically required to calculate or reasonably estimate payments at future times.

Existing calculation methods for path-dependent securities (derivatives) typically utilize economic assumptions to calculate underlying asset performance, asset payments, and security (derivative) payments in sequential process at each payment time starting at present and extending through the end of the investment analysis time horizon. The sequence of economic assumptions, asset performance, asset payments, and security (derivative) payments is referred to as a scenario or path. Discrete Scenario Analysis is computationally intensive and severely restricts the types of analyses that can feasibly be performed for path-dependent securities.

Security (derivative) evaluation and risk analyses are typically based on calculating the expected present value of cash-flows across a probability distribution of potential future economic scenarios. Due to path-dependency, existing technology typically utilizes Monte Carlo simulation techniques to represent probability distributions with a random sampling of future scenarios or paths. Economic assumptions, asset performance, asset payments, and security (derivative) payments are then calculated for each path. Expected present values and risk-management metrics are then calculated by averaging over the various paths. As each cash-flow in each scenario must be calculated individually, this methodology is computationally intensive and thereby restricts the feasible number of paths that systems may calculate within a specified amount of computation time. A very large number of paths is required to achieve computational accuracy and reliability for many types of path-dependent securities (derivatives), and/or when utilizing mathematically sophisticated probability models. The number of paths required to achieve computational accuracy and reliability often greatly exceeds the number than can be feasibly calculated in acceptable computation time.

A method called “Backwards Induction” provides more computationally efficient expected present value calculation algorithms in circumstances where the path dependency of payment calculation input variables at each time t is fully determined by the outstanding principal balance at time t. With Backwards Induction, expected present value calculations are modeled as solutions to partial differential (or difference) equations with terminal boundary conditions including an assumed final value for the security's principal balance. Backwards Induction is typically applied to generic types of securities (e.g., mortgage pass-through securities) for which scheduled principal amortization schedule at time t can be defined as a closed form mathematical function of principal balance at time t. To apply Backwards Induction, economic scenario forecast models used to generate payment calculation input variables may not include any path-dependent input variables other than outstanding principal balance at time t. This restriction severely limits the ability to use realistic economic scenario forecast models even when payment calculation rules are such that Backwards Induction can be technically applied. Attempts to include additional state variables to functionally summarize path dependency will geometrically increase computational requirements. More technologically complex uses of Backwards Induction are based on the following steps: 1) approximate securities by independent components, 2) independently analyze each component using Backwards Induction, and 3) recombine analyses after each component calculation is complete. Backward Induction methods either do not apply or break-down for many important path-dependent security types and mathematical forms of scenario forecast and payment calculation models.

Probabilistic loss models have been developed in the area of portfolio credit derivatives to provide calculations for expected losses based on probability distributions of underlying firm asset values. Security evaluation based on probabilistic loss models is conceptually similar to models used in equity derivatives. In equity derivatives, pricing models are often formulated as solutions to differential equations with boundary conditions based on future stock prices. Monte Carlo simulation is sometimes used for problems that are too mathematically difficult to approximate with closed form solutions. Probabilistic loss models are primary components of corporate credit derivative pricing and risk-management technology. Within these models, default is assumed to occur when underlying firm asset values fall below loan default barriers based on outstanding principal balance. Probability analysis of future defaults and losses can be quite complicated for all but the simplest probability distributions and debt structures. Because of mathematical and computational difficulty, normally distributed probability distributions are typically utilized. Existing technology typically will not accommodate more mathematically sophisticated correlations, non-normal tail events, or time dependence. Additionally, existing models typically assume loan principal balance schedules are fully known over investment horizon or else change in a very restrictive manner. Probabilistic loss models have not advanced to a point where they can be applied to securities with path-dependent principal balances such as the structured products described above. This is a very significant modeling problem, as structured product credit derivatives is a major industry growth area with very large embedded risks. The structured product credit derivative industry therefore depends primarily on discrete scenario analysis for pricing and hedging, which is inadequate for more complex loss options, CDO, and CDO-squared.

In summary, current structured product evaluation technologies utilize the following methods:
1) Discrete Scenario Analysis of future payments assuming discrete future scenarios for underlying collateral value, prepayments, defaults, losses, interest rates, and relevant economic variables;
2) Monte Carlo simulation of payments across multiple discrete scenarios, resulting in technology that is too computationally intensive to reliably calculate many types of securities and models;
3) Backward Induction numerical methods for subset of securities and probability models with a limited form of path-dependency; and
4) Probability Loss Models that require simplified probability forms and neglect stochastic behavior of path-dependent variables.

Each of these methods assumes a probability distribution for various economic variables that determine underlying asset performance and security (derivative) payments, and seeks to estimate expected present values of payments based on this probability distribution. Probability models are typically based on the stochastic evolution of state variables. Real-world probability models typically require multiple state variables, with mathematically sophisticated correlations, tail-events, and time-dependency.

Discrete Scenario Analysis is based on calculating results for a small number of potential scenarios, which can then be used for tracking prices and obtaining an “intuitive feel” for how the security (derivative) will behave in other scenarios. Discrete Scenario Analysis does not provide a consistent method to analyze mathematically uncertain outcomes.

Monte Carlo Simulation extends Discrete Scenario Analysis, but is limited by the exceedingly large number of sample paths required to numerically approximate a real-world probability models. Calculations based on smaller numbers of paths often generate significantly different results depending on which specific set of paths is used. This effect is unpredictable, and makes many important calculations highly unreliable. Alternatively, restrictive probability models do not include important state variables and statistically significant interactions among state variables.

Backwards Induction and Probability Loss Models seek to avoid this problem by using closed form mathematical solutions, which are inadequate for most securities (derivatives) and real-world probability models.

These technologies are inadequate for analyzing a large class of path-dependent securities (derivatives) and/or probability models. Hard mathematical problems pertain to the joint interaction of path dependency, correlations, and tail events. Significant industry research is directed at these problems, and new technology is needed.

### SUMMARY OF INVENTION

Methods and apparatus for calculating expected present values and conditional probabilities of future payments of path-dependent rules-based securities or derivative contracts using iterative conditional probability calculation methods include: breaking a payment horizon of a security (e.g., a derivative security) into N time increments assuming a starting time t=0 and ranging to time t=N; initializing an array of state variables to assumed values at t=0; applying transition probability models to the assumed values of the state variables at time t=0 to calculate a joint probability distribution for the state variables at time t=1; applying payment calculation models to both the t=0 and t=1 values of the state variables to calculate probabilities and expected present values for security (e.g., contract) payments occurring between t=0 and t=1 conditioned on values of the state variables at times t=0 and t=1; iteratively applying the transition probability models and the payment calculation models to values of the state variables, probabilities, and security (derivative) payments at each time t to calculate joint probability distributions for the state variables, probabilities, and expected present values of the security (contract) payments occurring between times t and t+1 conditioned on values of the state variables at times t and t+1; and summing conditional the probabilities and the expected present value calculations across time and values of the state variables to obtain the expected present values and conditional probabilities of the future payments of the path-dependent rules-based securities or derivative contracts.

The state variables may represent stochastic economic factors, results of payment calculation and forecast models, or functions used to facilitate computations. Implementation of calculation methods (embodied within mathematical models, algorithms, and software) employs specialized techniques to increase computational efficiency than other methods, and enable usage of mathematically sophisticated state variables, transition probability models, and payment calculation models.

Iterative Conditional Probability Calculation Methods in accordance with at least one embodiment of the present invention are fundamentally different from existing methods used to evaluate securities and derivative contracts with path-dependent and stochastic payment calculation and payment forecast models because they: (i) iteratively compute an array of state-dependent conditional expected present values at each time step; and (ii) the number of computation steps required to perform expected present value calculations across a grid of time steps and values of state variables is less than a pre-defined bounded constant number times (the number of time steps) times (the total number of possible states at each time step) times (the maximum number of non-zero transition probabilities for a given state at each time step).

The Iterative Conditional Probability Calculation Methods in accordance with at least one embodiment of the present invention are also fundamentally different from existing methods because they use the following computation techniques: (i) employment of endogenous stochastic state variables for each value of exogenous state variables at each time increment to create probability distributions of pool attributes and outstanding balances resulting from different paths the exogenous state variables may take to arrive at their particular values at the particular time increment; (ii) iterative calculation of a grid of probability-weighted conditional expected present value outstanding loan balances for possible values of endogenous and exogenous state variable balances at each time increment; (iii) achievement of greater computational efficiency by breaking the iterative computation into a multiplication of time-dependent and state-independent adjustment factors and a grid of state-dependent and time-independent adjustment factors. The time-dependent adjustment factors may be constructed to summarize expected payments and interest rate discounting factors for one designated path of interest rates and stochastic state variables up to that time step. The state-dependent adjustment factors may be constructed as transition probability weighted expected value and one-time-step state variable and factor balance adjustments.

In accordance with one or more embodiments of the present invention, methods and apparatus for calculating expected present values and conditional probabilities of future payments of path-dependent rules-based securities or derivative contracts using iterative conditional probability calculation methods, include: (a) breaking a payment horizon of the securities or derivative contracts into N time increments over time t=0 to t=N; (b) initializing an array of state variables to assumed values at t=0; (c) applying transition probability models to the assumed values of the state variables at time t=0 and calculating a joint probability distribution for the state variables at time t=1; (d) applying payment calculation models to both the t=0 and t=1 values of the state variables and calculating probabilities and expected present values for the securities or derivative contracts payments occurring between t=0 and t=1 based on values of the state variables at times t=0 and t=1; (e) repeating steps (c)-(d) iteratively at each time t and calculating joint probability distributions for the state variables, probabilities, and expected present values of the the securities or derivative contracts payments occurring between times t and t+1 based on values of the state variables at times t and t+1; (f) making a computation using the probabilities and the expected present value across time and values of the state variables to obtain the expected present values and conditional probabilities of the future payments of the path-dependent rules-based securities or derivative contracts; and (g) outputting at least the expected present values of the securities or derivative contracts on a user readable medium.

In accordance with one or more further embodiments of the present invention, methods and apparatus for calculating expected present values and conditional probabilities of future payments of path-dependent rules-based securities or derivative contracts using iterative conditional probability calculation methods, include: establishing system inputs including at least one of loan characteristics, interest rate(s), prepayment and default forecast model parameters, home price index, and initial value of borrower health index representing loan pool creditworthiness and refinance responsiveness; calculating an R(t) and an array TY(t), relating to forward short-term discounting rates and longer maturity reference rates for loan refinancing for each time increment; calculating an HPI(t) array, relating to expected forward values of home price index; calculating an MIN_PPY(t) array and an MIN_DEF(t) array, relating to minimum percentage principal amortization, prepayments, and defaults; calculating an PV_BAL1(t) based on R(t), relating to present values of remaining principal balances at each time t; iteratively calculating probabilities and conditional expected present-values across possible states over time increments; creating a grid of possible values of TY, HPI, and BHI, where BHI is a state variable relating to borrower health index; calculating transition probabilities, for each time t, for the state variables TY and HPI; calculating the state variable BHI across all states TY, HPI, BHI for each time t; calculating the expected present value of principal, interest, defaults, and losses received at each time t as a summation across state variables (TY, HPI, BHI) of the percentage principal, interest, defaults, and losses which occur in the particular state; and calculating a total expected present value of principal, interest, and loss payments by summing across t of the expected present values of principal interest, and loss payments at each time t.

In accordance with one or more further embodiments of the present invention, methods and apparatus for calculating expected present values and conditional probabilities of future payments of path-dependent rules-based securities or derivative contracts using iterative conditional probability calculation methods, include: establishing a time sequence t(j), j=0 to N; establishing a path-dependant data stream S(j), which is not completely known at time t(M), M greater than 0 and less than N, and is a determinate of at least the future payments of the securities and/or derivative contracts; establishing a path-dependent data stream Z(j), which is not completely known at time t(M) and contains qualitative data of the securities and/or derivative contracts; establishing a composite data stream SZ(j), each SZ(j) comprises the data S(j) and the data Z(j), and the composite data stream SZ(j) is not completely known at time t(M), wherein for any given path of SZ(j) up to time t(M), a probability distribution for SZ(M+1) is a function of t(M), t(M+1) and SZ(M) and is independent of SZ(j), where j is less than M; and computing the expected present values and conditional probabilities of future payments of path-dependent rules-based securities and/or derivative contracts using the data stream SZ(j).

Other aspects features and advantages of the present invention will become apparent to those of ordinary skill in the art when the description herein is taken in conjunction with the accompanying drawings.

### BRIEF DESCRIPTION OF THE DRAWINGS

For the purposes of illustration, forms are shown in the drawings that are preferred, it being understood that the invention is not limited to precise arrangements or instrumentalities shown.

FIG. 1 illustrates a block diagram of a computing system operable to carry out actions and functions suitable for calculating expected present values and conditional probabilities of future payments of path-dependent rules-based securities or derivative contracts using iterative conditional probability calculation methods;

FIG. 2 is a flow diagram illustrating process steps carried out using the system of FIG. 1;

FIG. 3 is a combined state and timing diagram illustrating some characteristics of existing techniques for calculating expected present values and conditional probabilities of future payments of path-dependent rules-based securities or derivative contracts; and

FIG. 4 is a combined state and timing diagram illustrating some characteristics of one or more embodiments of the present invention in connection with calculating expected present values and conditional probabilities of future payments of path-dependent rules-based securities or derivative contracts.

### DETAILED DESCRIPTION OF THE EMBODIMENTS OF THE INVENTION

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment.

One or more embodiments of the present invention are generally directed to the analysis of current prices, future expected prices, and future expected cash-flows of path-dependent securities, synthetic, and derivative contracts using probability models for changes in collateral value, prepayments, defaults, losses, interest rates, and relevant economic variables. One or more aspects of the invention are particularly applicable to structured product securities in which cash-flows are determined by bond calculation rules based on the magnitude and timing of interest rates and loan portfolio losses and prepayments.

One or more embodiments of the invention are applicable to any of the financial products mentioned hereinabove, including but not limited to ABS, MBS, CMBS, CMO, CDO, and CLO. One or more further aspects of the present invention may be applied to synthetic (e.g., derivative) products based off (or derived from) structured product assets, such as synthetic CDO, synthetic CLO, credit default swap (CDS), and single-tranche structured product CDS. One or more further aspects of the present invention may be applied to equity and debt securities issued by Real Estate Investment Trusts (REIT(s)), and/or financial contracts and securities referred to as “Property Derivatives”. Property derivatives may be based on commercial real estate property income, capital appreciation, or return, or alternatively on residential real estate home price indices.

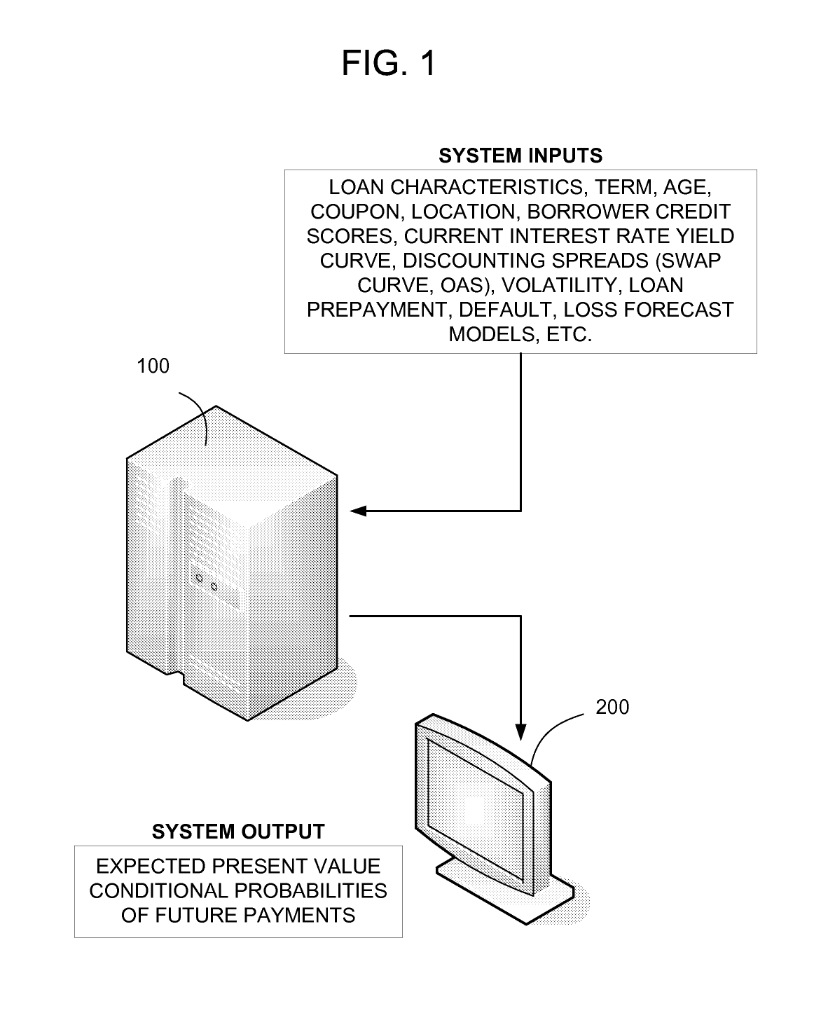

With reference to FIG. 1 and the description herein, it will be apparent to those having skill in the art that software as described and disclosed herein may be used in conjunction with, run on and/or employed with one or more computers 100. For example, in at least one embodiment applications of the present invention may be provided in the form of software on a stand-alone computer, on a network server; and/or available via a wide area network such as but not limited to a LAN or the internet.

In accordance with one embodiment of the present invention, a probability distribution for security (derivative) payments is modeled by the stochastic evolution of an array of K independent (but potentially correlated) state variables labeled j=1 to K. This stochastic evolution can be numerically represented by an iteratively generated set of possible values for these state variable at a discrete number future times (t=1 to N). The numerical representation will typically specify initial values for the set of state variables, as well as transition probabilities that can be used to calculate probabilities at possible values at each successive time step. Typically, the numerical representation will assign non-zero transition probabilities for a relatively small number nj of possible changes in each state variable (indexed by j) at each time step t. For example, state variable j may be allowed to stay the same or change one increment up or down, in which case nj=3. The number mj(t) of assumed possible values for a given state variable j will typically increase with t, usually up to some maximum number. For some state variables (e.g., interest rates), a relatively large number (e.g. 100) of possible values may be required to achieve reasonable computational accuracy for securities with option-like features (e.g., interest rate caps or leveraged prepayment options). For other state variables (e.g., average borrower credit score or average home price appreciation for geographically defined loan subset) the maximum number may be relatively small (e.g., 2, 3, 4, or 5).

Once a numerical representation for the probability distribution has been defined, methods and/or software in accordance with one embodiment of the present invention generate state variables and transition probabilities at each time increment t. The maximum number of possible values for the multi-dimensional array of state variable at each time t equals the product Max_Num_States(t)=m1(t)* . . . *mk(t). The maximum number of transition probabilities required to be calculated at each time t is Max_Num_Probs(t)=MV(t)*n1(t)* . . . nk(t). The maximum numbers of state variable values and transition probabilities at each time t are determined by how finely the probability distribution of possible state variables is parsed, and can be selected independently of the number N of time steps. Summing over all time steps, the total number of possible states equals N* Max_Num_States and the total number of transition probabilities over all time periods equals N*Max_Num_Probs.

In one or more embodiments, the present invention differs fundamentally from Monte Carlo simulation at least in the manner in which transition probabilities and state variables are utilized to numerically approximate the expected present value of cash-flows across possible outcomes. Monte Carlo uses values of state variables and transition probabilities to generate time-dependent paths and calculate probabilities for those time-dependent paths. The number of possible paths of state variables is exponentially larger than the number of states and transition probabilities and grows geometrically with both N and K. Even with relatively small values of N and K, the number of possible paths typically far exceeds the number that can be reasonably calculated for real-time problems. Monte Carlo Simulation is therefore based on averaging across a much smaller number of sample paths, thereby severely limiting numerical accuracy for many types of securities and models with more than one state variable.

One or more aspects of the present invention may be fundamentally different than Monte Carlo at least in that they calculate the expected present value of cash-flow at each time step conditioned on the value of the array of state variables the respective time. For example, in accordance with one embodiment, the invention may iteratively calculate transition probabilities, conditional probabilities and conditional expected present values for security (derivative) payments for each possible state at each time step based on calculations from the prior time step. Rather than calculating cash-flows across discrete time paths, path-dependent information about prior time periods is probabilistically summarized at each time step for use at the next time step. Computational requirements are therefore proportional to the total number of transition probabilities that must be computed, thereby allowing for a much richer set of state variables and much greater numerical accuracy for the same amount of computation.

The above-described aspects of the present invention represent technological advancements over Monte Carlo and other existing methods. They represent a conceptually different approach based on using conditional probabilities to probabilistically summarizing path-dependent information in a discrete number of state variables rather than calculating payments along each path. Computational requirements grow linearly with N, rather than exponentially with N, as with Monte Carlo.

Thus, in accordance with one or more embodiments of the present invention: (i) it is feasible to utilize real-world probability models that include multiple state variables, correlations, tail-events, and path-dependency; (ii) the analysis of effects of statistical relationships among economic variables representing borrower financial health, income, and loan collateral value is enabled; (iii) the analysis of the effects of adverse selection in the refinancing process, and the consequent path-dependent interaction of interest rates, prepayments, defaults, and economic variables are enabled; and (iv) the calculation of expected present values and risk metrics in relation to these variables that are then used for evaluating and hedging securities and derivative contracts is enabled.

An application of one or more embodiments of the invention is in the field of payment forecast modeling, where the calculation of expected present values of interest, principal, defaults, and losses of residential mortgage-backed securities (MBS) is performed.

Interest and principal payments typically occur on a monthly basis and are comprised of principal and interest payments collected from the underlying pool of mortgage loans backing the MBS, less various loan servicing and security administration fees. For fixed rate mortgages, interest payments will typically be modeled as a fixed percentage of outstanding balances of loans deemed not to be in default. Principal payments are typically modeled as scheduled amortization on loans outstanding, plus prepaid principal calculated as a percentage of outstanding loans, plus recoveries on loans that have been removed from outstanding balance due to default. Prepaid and defaulted loans are removed from the calculation of loans outstanding and therefore of interest. Proceeds obtained from the liquidation of defaulted loans are used to reimburse delinquent interest prior to being classified as in default, therefore resulting in lower recovery rates.

Elaborate statistical models have been created to forecast principal prepayments, defaults, and losses and functions of interest rates, loan characteristics, and economic state variables such as average property values and average incomes on geographically defined subsets of loans. Change in interest rates is a primary determinant of principal prepayments due to refinancing incentives from lower mortgage rates. There are established theories and accepted industry methodologies for creating probability distributions for interest rates that are consistent with observed market prices of fixed income securities and benchmark options on those securities (namely, treasury securities, interest rate swaps, and options on those treasuries and swaps). A commonly used methodology is based on what's called HJM theory, based on research by Heath, Jarrow, and Morton. Interest rate models may have one or more stochastic variables. Prepayment, default, and loss models may also include one or more stochastic variables.

Integration of interest rate, prepayment, default, and loss models provides a multifactor stochastic model for MBS interest, principal, defaults, and losses. Statistical forecasting errors can be reduced by building more elaborate models with a greater number of stochastic variables so as to better incorporate statistically significant functional relationships. Incorporation of new factors will often significantly effect expected present value calculations for MBS interest, principal, and losses.

The technological challenge for evaluating MBS securities and derivatives is that expected present value calculations are mathematically and computationally difficult for even the more simplistic forecast models. This is because of the exponentially large number of possible payment scenarios and the inability to derive closed form solutions for path-dependent securities and stochastic state variables. The implication is that current evaluation methods cannot incorporate important statistical information that significantly impacts payments and values of MBS interest, principal, and losses.

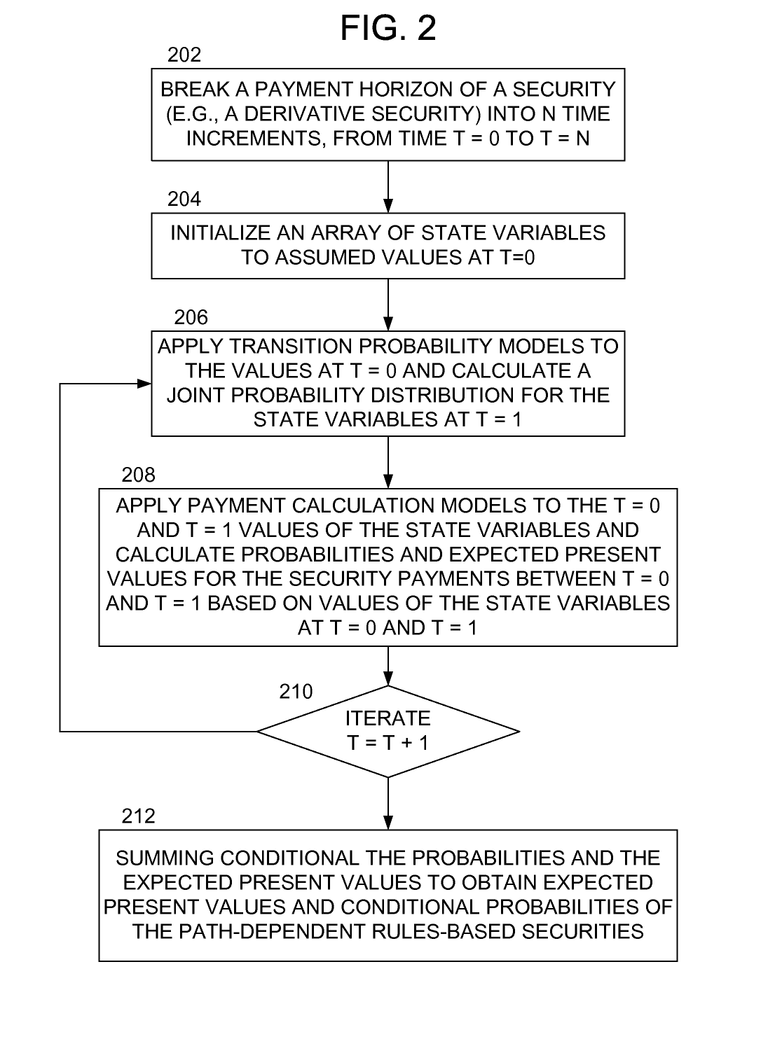

An example prepayment, default, and loss model of residential mortgage-backed securities (MBS) in accordance with one or more embodiments of the invention is provided below and with reference to FIG. 2, steps 202-212. This example embodiment of the invention may include specifying a payment forecast model with multiple stochastic state variables.

First, a number of inputs are established, including loan characteristics such as term, age, coupon, location, and borrower credit scores. These inputs are divided into “loan” buckets. Further inputs may also include current interest rate yield curve, discounting spreads (swap curve, OAS), and volatility assumptions. Economic variables effecting the loan buckets with expected returns, volatility, and correlations are determined and specified. Loan prepayment, default, and loss forecast models and model parameters may also be established as inputs. Numerical settings relating to time-steps and state-variable increments are also established.

Next, the inputs are used to define a time-dependent, non-stochastic principal amortization and base-case minimum percentage prepayment due to assumed minimum amount of housing turnover, cash-takeout refinancing, or debt reduction that would occur even in “worst-case” economic environment. The input are also used to define a time-dependent, non-stochastic base-case minimum percentage loan defaults due to assumed minimum amount of idiosyncratic borrower defaults that would occur even in a “best-case” economic environment.

The inputs are also used to define stochastic monthly percentage principal prepayments due to refinancing determined by: a) refinancing incentive based on the amount by which the stochastic 10-year US Treasury Note yield falls below loan coupon rates; b) cash-takeout refinancing opportunities based on economic state variable; c) magnitude of response to refinancing incentive and cash-takeout opportunities based on stochastic economic state variables and adverse selection.

The inputs are also used to define stochastic monthly percentage defaults and loss severity due to borrow financial stress determined by stochastic interest rates, economic state variables, and adverse selection.

Statistical relationships among state variables corresponding to borrow financial health and home prices across loan buckets are primary determinants of loan prepayments, defaults, losses, and MBS investment value. The effects of these state variables interact with stochastic interest rates through both direct correlation and through adverse selection in the prepayment process. Adverse selection is a primary determinant of prepayments, defaults, losses, and MBS investment value. Adverse selection is by its nature highly path-dependent.

Stochastic state variables, adverse selection, and path-dependency are required to reasonably model and analyze the primary determinants of MBS investment value. Existing security evaluation methods are technologically inadequate for calculating expected present values to an acceptable accuracy for models with these important features.

An aspect of the invention is the use of stochastic state variables to model adverse selection and path-dependency within payment forecast models. In one embodiment, the invention provides a computational solution as illustrated in the following section, where an example algorithm design si discussed in the MBS context.

In this example, a 1-factor interest rate model, 1 exogenous economic state variable, and 1 path-dependent endogenous state variable are utilized. The 1-factor interest rate model is based on HJM theory. The exogenous state variable represents average home prices and economic health across the entire loan pool as of the analysis date. The endogenous state variable represents pool credit-worthiness and responsiveness to refinancing opportunities. The algorithm is adapted in straightforward manner to more interest rate and state variables, in which case computation time increases in proportion to the total number of states possible at each time-step.

Using 1 interest rate factor and 2 state variables, approximately 5 million floating point operations is required to obtain sufficient accuracy for loan portfolio analysis and security trading. 5 million operations requires approximately ( 1/100) second on a standard PC. Adding a new state variable with 10 possible states at each time step would therefore increase computation time by a factor of 10.

The following steps in the algorithm are carried out:

Inputs are established and made: (i) Loan characteristic (term, WAC, WAM, etc); (ii) Interest rates (US treasury yield curve, discounting spreads, volatility); (iii) Prepayment and default forecast model parameters (controls interaction between loan characteristic and state variables, defined based on product knowledge and statistical analysis); (iv) Home price index (expected annual changes and volatility); (v) Initial value of borrower health index representing loan pool creditworthiness and refinance responsiveness (defined based on pool analysis and market conditions); and (vi) Numerical parameters (time steps, state variable increments, maximum values).

An R(t) array and a TY(t) array are calculated, which relate to forward short-term discounting rates and longer maturity reference rates for loan refinancing for each time increment. HJM theory is used to adjust forward rates for volatility assumption so that R and TY equal means of arbitrage-free probability distributions.

An HPI(t) array is calculated, which relates to expected forward values of home price index.

An MIN_PPY(t) and an MIN_DEF(t) arrays are calculated, which relate to minimum percentage principal amortization, prepayments, and defaults. Additionally, R(t) (discussed above) is used to calculate an array labeled PV_BAL1(t), which relates to present values of remaining principal balances at each time t, assuming the minimum prepayment and default amounts. It is noted that with minor adjustments in the algorithm, minimum prepayments and defaults may be replaced by expected prepayments and defaults assuming mean forward interest rates and home prices.

Next, a main calculation loop involves iteratively stepping through time and calculating probabilities and conditional expected present-values across possible states. In the current algorithm, time steps are divided into epochs based on sizes of time steps. Sizes of interest rate (R, TY) and home price index (HPI) state-variable increments are determined jointly by size of time steps and volatility. Corresponding increment sizes are then used for the borrower health index (BHI). Acceptable accuracy may be obtained using 3 epochs, with 3 month time steps in epoch 1, 6 months in epoch 2, and 1 year in epoch 3. Finer adjustments may be made in the first few time steps to account for assumed lagged responses in prepayments and defaults to recent historical interest rates and economic variables.

At the start of each epoch e, a three dimensional grid of possible values of TY, HPI, and BHI is created. A reasonable number of possible states for HPI and BHI is 5 each. The number of possible states TY states will increase with time up to a maximum of approximately 50 (due to assumed maximum and minimum values). The total number of possible states at each time steps will therefore be on the order of 1000. Note that R(t)=TY(t)+offset(t) in a 1-factor interest rate model.

For each time t, transition probabilities are calculated for the exogenous state variables TY and HPI. For each state, 3 non-zero transition probabilities are created—probabilities of staying the same, moving up 1 increment, moving down 1 increment. Since drift and volatility are state-independent in the current implementation, this calculation depends only on the time (which determines drift, time increment, and state variable increment). At the endpoint of each state variable array, the probability of extending one increment beyond the endpoint is added to the probability of staying the same. Grid increments are such that this adjustment is numerically insignificant. Some additional work is required at the last time-step in each epoch to transition to a grid with different increments.

For each time t, a loop of transition probabilities of the endogenous state variable BHI is calculated across all states labeled (TY, HPI, BHI). The BHI transition probability calculation depends on the drift in HPI, as well as adverse selection due to prepayments and defaults that the model forecasts will occur in time-state point (t, TY, HPI, BHI). Prepayment and default functions equal MIN_PPY (t)+ADD_PPY (TY, HPI, BHI) and MIN_DEF (t)+ADD_DEF (TY, HPI, BHI). The MIN functions (discussed above) are calculated at each time step. The ADD functions are not assumed to depend on time in the current implementation, but time-dependency may be added with insignificant percentage increase in computation time. Transition probabilities for BHI (staying the same, moving up and down by 1 increment) are then calculated according to drift in HPI and the adverse-selection model.

Conceptually, financially healthy borrowers are assumed to exit the pool in proportion to prepayments and financially unhealthy borrowers are assumed to exit the pool in proportion to defaults. As in the calculation of the loop of transition probabilities of the endogenous state variable BHI (above), numerically insignificant adjustments are made at the endpoints of possible BHI values and at the last time-step in each epoch. Other minor adjustments may be made in the first few time steps to account for assumed lagged responses in prepayments and defaults to recent historical interest rates and economic variables.

In addition to calculating BHI transition probabilities for each time-state, the current loop also calculates a 1-step adjustment factor to the state-dependent expected present value of the principal balance outstanding at time t, which is labeled ADJ_PV_BAL (TY, HPI, BHI). This adjustment factor is the product of the balance reduction due to state-dependent prepayments and defaults and the expected value reduction due to the difference between TY and the mean of the rate distribution. This factor will be applied at each time

The expected present value of principal, interest, defaults, and losses received at each time t are then calculated as a summation across state variables (TY, HPI, BHI) of the percentage principal, interest, defaults, and losses which occurs in the particular state (determined by payment forecast model) multiplied by a function G (TY, HPI, BHI, t), which equals the probability of being in the particular state at time t times the expected present value of the outstanding principal balance conditioned on being in the state at time t. The function G(TY, HPI, BHI, t) is calculated iteratively as the transition-probability-weighted sum of G(-, -, -, t-1) x ADJ_PV_BAL(-, -, -) across all states which have no-zero probability of transitioning to (TY, HPI, BHI) from time t-1 to time t. G is initialized at time t=0 so that G(TY, HPI, BHI, 0) is non-zero if and only if each of the three state variable is within 1 state variable increment of the initial time t=0 value of that particular state variable, in which case G(TY, HPI, BHI, 0) equals the product across all three state variables of [1 minus the distance that each variable is from the initial time t=0 value divided by the state variable increment)]. Linear interpolation is utilized to extend G across the endpoints of each epoch e.

The total expected present value of principal, interest, and loss payments equals the sum across t of the expected present values of principal interest, and loss payments at each time t.

It is noted that for structured product securities with multiple payment classes and payment priorities, it will often be necessary to utilize percentage pay-downs of first-priority classes as endogenous state variables in forecast models for second priority classes. The same algorithm design will apply, albeit with more state variables and additional complexity.

Another embodiment of the present invention provides for methods and apparatus for computing the expected present value of a cash flow CF with respect to a probability measure mu. A sequence of times t(0), t(1), . . . , t(N), with each t(j+1) being later than t(j) is established. A time t(M) prior to the last time t(N) but subsequent to the first time t(0) is also established.

An S-Data stream includes data S(0), S(1), . . . , S(N), where each S(j) is associated with the corresponding time t(j), the S-Data stream is not completely known at time t (M), and the cash flow CF is determined by the S-Data stream. Two possible scenarios for the S-Data stream up to time t(M) are the A-Scenario SA(0), SA(1), . . . , SA(M), and the B-Scenario SB(0), SB(1), . . . , SB(M), where SA(M)=SB(M). The probability distribution for S(M+1) assuming the validity of the A-Scenario is different from the probability distribution for S(M+1) assuming the validity of the B-Scenario.

A Z-Data stream includes data Z(0), Z(1), . . . , Z(N), where each Z(j) is associated with the corresponding t(j), and the Z-Data stream is not completely known at time t(M). Two possible scenarios for the Z-Data stream up to time M are the p-Scenario Zp(0), Zp(1), . . . , Zp(M), and the q-Scenario Zq(0), Zq(1), . . . , Zq(M), where Zp(M)=Zq(M). The probability distribution for Z(M+1) assuming the validity of the p-Scenario is different from the probability distribution for Z(M+1) assuming the validity of the q-Scenario.

A composite data stream comprises data SZ(1), SZ(2), . . . , SZ(N), with each SZ(j) associated with the corresponding time t(j). Each SZ(j) comprises the data S(j) and the data Z(j), and the composite data stream SZ(0), . . . , SZ(N) is not completely known at time t(0). For any possible scenario SZp(0), SZp(1), . . . , SZp(M) for the composite data stream up to time t(M), the probability distribution for SZ(M+1) assuming the validity of the said scenario is determined by t(M), t(M+1) and SZp(M), independently of SZp(0), . . . , SZp(M−1).

The probability distribution for SZ(M+1) assuming a given value for SZ(M) is used to compute the expected present value of the cash flow CF with respect to the probability measure mu.

In a typical MBS example, S(j) consists of mortgage principal and interest payments, prepayments and defaults, together with housing price info and interest rates, all at time t(j). It is path dependent. The Z(j) consists of pool quality information at time t(j), which is a sort of “hidden state variable.” By itself it is path dependent. In the prior art, with fast and slow pre-payers, the hidden state variable is time-independent, the very opposite of path-dependent. Although the S-process and the Z-process are path dependent (and therefore hard to compute with prior art techniques), the composite process consisting of S and Z together is Markov (i.e., not path dependent) and therefore much easier than the S process considered alone.

In order to provide further clarification of various aspects of the present invention, a simplified embodiment thereof will now be discussed. In this example, the cash flow of a pool of mortgages is calculated at least in part based on the percentage of the mortgages in the pool that are prepaid, e.g., due to refinancing. Those skilled in the art will appreciate that many other determinates for the cash flow may exist in practice; however, this particular determinate (% prepayments) will be focused upon in this example.

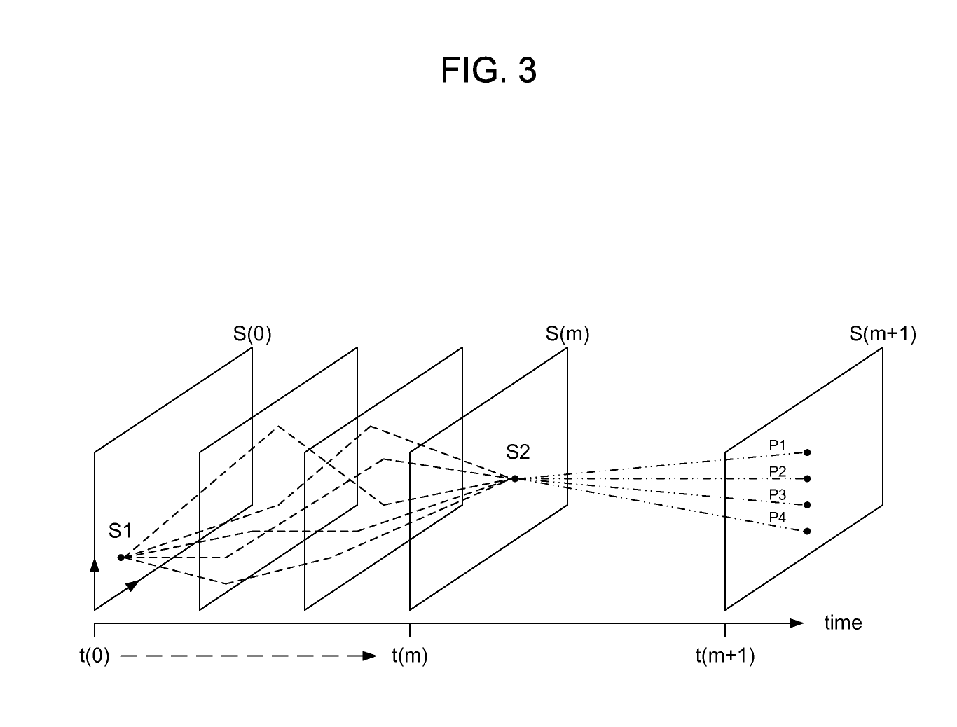

As an initial matter, a brief discussion of the problem with prior art techniques of computing the cash flow, even for this simplified example, will be discussed to provide context for this embodiment. With reference to FIG. 3, the data set S at each point in time t is multi-dimensional, in this example two dimensional, and includes the current interest rate and the outstanding loan balance of the pool. Thus, the aggregate data series S includes S(0), S(1), S(2) . . . S(m), S(M+1), . . . S(N). There are potentially an infinite number of paths (indicated in dashed lines) from an initial point S1 in the S(0) space to an intermediate point S2 in the S(m) space. Prior art computational techniques for computing the probability distribution Pi of particular % prepayments and/or outstanding balances at time t=m+1 are path dependent. Thus, to get a reasonable degree of accuracy in computing the probability distribution Pi, a computationally intensive (and likely impractical) process of taking the transition probabilities into consideration is required.

Consider just two scenarios (paths) that could exist in this example between point S1 and S2, assuming an average loan rate of 8% for the pool of mortgages: Scenario 1—the rate mostly remained above 8% between time t=0 and t=m, until falling to a current rate of 6% at time t=m. Scenario 2—the rate mostly remained below 8% between time t=0 and t=m, until rising to a current rate of 6% at time t=m. The % prepayment and outstanding balance at time t=m+1 is therefore dependant on which path (Scenario 1 or Scenario 2) is taken between t(0) and t(m). If Scenario 1 is taken, relatively few borrowers would likely have refinanced between t(0) and t(m), resulting in a high probability that the % prepayment is low and the outstanding balance is high. If Scenario 2 is taken, a relatively large number borrowers would likely have refinanced between t(0) and t(m), resulting in a high probability that the % prepayment is high and the outstanding balance is lower. As there would be a potentially infinite number of scenarios, determining the probability distribution for the % prepayment and outstanding balance of the pool is highly computationally intensive.

In accordance with one or more aspects of the present invention, however, one or more hidden state variables Z are constructed and used to summarize (or as a substitute for) the information provided by path dependencies and associated transition probabilities. For example, as discussed above, a borrower health index (BHI) may be constructed, which is an indicator of the overall qualitative characteristics of the borrower pool. Such characteristics may include: the creditworthiness of the borrowers, the gross incomes of the borrowers, the credit scores of the borrowers, etc. The BHI in combination with one or more of the data components of the S data set (e.g., in this example, the current interest rate and the outstanding loan balance of the pool) is path independent, and may provide sufficient information to compute the probability distribution of the determinant at time t=m+1. Expressed mathematically, Pi(m+1)=f(SZ(m)).

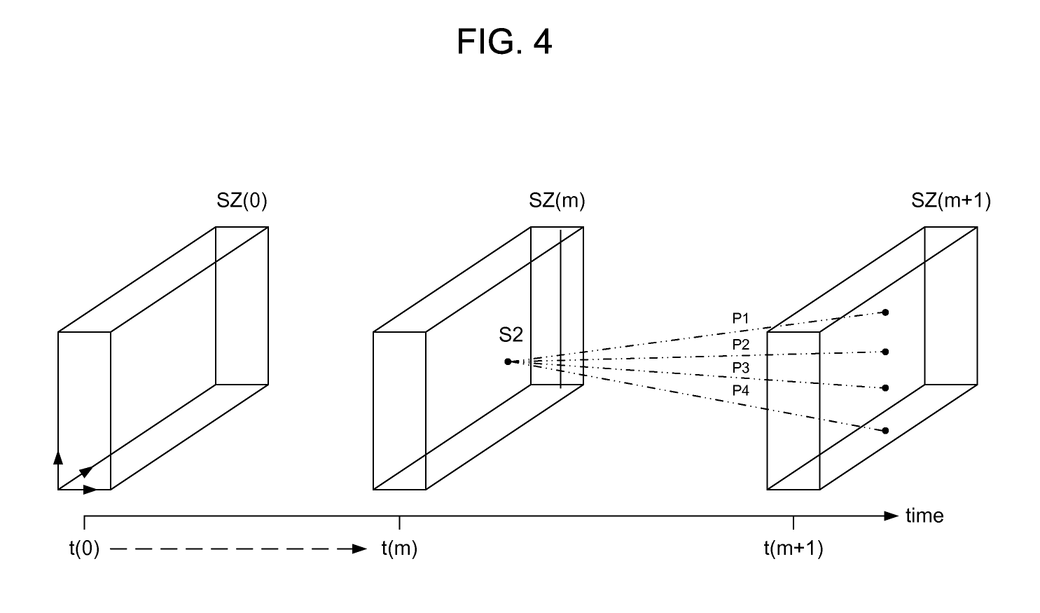

The above relationships as shown graphically in FIG. 4. At each time interval t, the combined S data set and Z data set, SZ(t), is represented as a three dimensional volume, where the additional dimension (as compared with FIG. 2) is a result of the hidden state variable Z=BHI. There are no paths between the time intervals because the BHI state variable summarizes (or represents) that information since it contains qualitative information on the pool of mortgages. Thus, the probability distribution Pi at time t=m+1 is a function of the data set SZ(m), and is calculated directly therefrom. Indeed, if through calculation SZ(m) establishes that the outstanding balance of the pool is relatively high and the BHI is high, then the resulting calculation is that the % prepayments is low. Why?—Because, as discussed above, significant refinancing activity over time results in a lower outstanding balance and resultant pool of relatively poor quality (poor health) borrowers.

Thus, the composite data series SZ(t) permits a computation of cash flow at SZ(m+1) based only on SZ(m), which is not path-dependant and may be carried out using Markov modeling techniques.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Appendix

The following visual basic code is extracted from a software program in accordance with one embodiment of the invention directed to MBS. Variable declarations and auxiliary computations have been deleted, and comments have been included so that the code parallels the algorithm described in the section above.

1. A method for calculating expected present values and conditional probabilities of future payments of path-dependent rules-based securities or derivative contracts using iterative conditional probability calculation methods, comprising:
(a) breaking a payment horizon of the securities or derivative contracts into N time increments over time t=0 to t=N;
(b) initializing an array of state variables to assumed values at t=0;
(c) applying transition probability models to the assumed values of the state variables at time t=0 and calculating a joint probability distribution for the state variables at time t=1;
(d) applying payment calculation models to both the t=0 and t=1 values of the state variables and calculating probabilities and expected present values for the securities or derivative contracts payments occurring between t=0 and t=1 based on values of the state variables at times t=0 and t=1;
(e) repeating steps (c)-(d) iteratively at each time t and calculating joint probability distributions for the state variables, probabilities, and expected present values of the the securities or derivative contracts payments occurring between times t and t+1 based on values of the state variables at times t and t+1;
(f) making a computation using the probabilities and the expected present value across time and values of the state variables to obtain the expected present values and conditional probabilities of the future payments of the path-dependent rules-based securities or derivative contracts; and
(g) outputting at least the expected present values of the securities or derivative contracts on a user readable medium.

2. A method for calculating expected present values of future payments of one or more path-dependent, rules-based financial instruments using iterative conditional probability calculation methods, comprising:
establishing system inputs including at least one of loan characteristics, interest rate(s), prepayment and default forecast model parameters, home price index, and initial value of borrower health index representing loan pool creditworthiness and refinance responsiveness;
calculating an R(t) and an array TY(t), relating to forward short-term discounting rates and longer maturity reference rates for loan refinancing for each time increment;
calculating an HPI(t) array, relating to expected forward values of home price index;
calculating an MIN_PPY(t) array and an MIN_DEF(t) array, relating to minimum percentage principal amortization, prepayments, and defaults;
calculating an PV_BAL1(t) based on R(t), relating to present values of remaining principal balances at each time t;
iteratively calculating probabilities and conditional expected present-values across possible states over time increments;
creating a grid of possible values of TY, HPI, and BHI, where BHI is a state variable relating to borrower health index;
calculating transition probabilities, for each time t, for the state variables TY and HPI;
calculating the state variable BHI across all states TY, HPI, BHI for each time t;
calculating the expected present value of principal, interest, defaults, and losses received at each time t as a summation across state variables (TY, HPI, BHI) of the percentage principal, interest, defaults, and losses which occur in the particular state; and
calculating a total expected present value of principal, interest, and loss payments by summing across t of the expected present values of principal interest, and loss payments at each time t.

3. A method for calculating expected present values and conditional probabilities of future payments of path-dependent rules-based securities and/or derivative contracts using iterative conditional probability calculation methods, comprising:
establishing a time sequence t(j), j=0 to N;
establishing a path-dependant data stream S(j), which is not completely known at time t(M), M greater than 0 and less than N, and is a determinate of at least the future payments of the securities and/or derivative contracts;
establishing a path-dependant data stream Z(j), which is not completely known at time t(M) and contains qualitative data of the securities and/or derivative contracts;
establishing a composite data stream SZ(j), each SZ(j) comprises the data S(j) and the data Z(j), and the composite data stream SZ(j) is not completely known at time t(M), wherein for any given path of SZ(j) up to time t(M), a probability distribution for SZ(M+1) is a function of t(M), t(M+1) and SZ(M) and is independent of SZ(j), where j is less than M; and
computing the expected present values and conditional probabilities of future payments of path-dependent rules-based securities and/or derivative contracts using the data stream SZ(j).
